(19) United States
(12) Patent Application Publication
(10) Pub. No.: US 2001/0005009 A1
(43) Pub. Date: Jun. 28, 2001

(54) Slurry for chemical mechanical polishing

(76) Inventors: Yasuaki Tsuchiya, Tokyo (JP); Tomoko Wake, Tokyo (JP); Tetsuyuki Itakura, Tokyo (JP); Shin Sakurai, Tokyo (JP); Kenichi Aoyagi, Tokyo (JP)

Correspondence Address: Paul J. Esatto, Jr., Scully, Scott, Murphy & Presser, 400 Garden City Plaza, Garden City, NY, 11530, US

(21) Appl. No.: 09/752,400

(22) Filed: Dec. 28, 2000

(30) Foreign Application Priority Data
Dec. 28, 1999 (JP) 374485/1999

(51) Int. Cl. C09K 5/00

(52) U.S. Cl. 252/79

(57) ABSTRACT

In chemical mechanical polishing of a copper metal film, contamination of a polishing pad may be prevented by using a slurry for chemical mechanical polishing consisting of θ-alumina which mainly comprises secondary particles made of aggregated primary particles as polishing grains.

### BACKGROUND OF THE INVENTION

This invention relates to a slurry for chemical mechanical polishing used in manufacturing a semiconductor device. In particular, it relates to a slurry for chemical mechanical polishing suitable for forming a copper damascene interconnect.

With regard to forming a semiconductor integrated circuit such as ULSI which has been significantly refined and compacted, copper has been expected to be a useful material for electric connection because of its good electromigration resistance and lower electrical resistance.

To date a copper interconnect is formed as follows due to problems such as difficulty in patterning by dry etching. Specifically, a concave such as a trench and a connection hole is formed in an insulating film, a barrier metal film is formed on the surface, a copper film is deposited over the whole surface by plating such that the concave is filled with the material, and then the surface is polished to be flat by chemical mechanical polishing (hereinafter, referred to as “CMP”) until the surface of the insulating film except the concave area is completely exposed, to form electric connections such as a damascene connection interconnect in which the concave is filled with copper, a via plug and a contact plug.

There will be described a process for forming a damascene copper interconnect with reference to FIG. 3.

As shown in FIG. 3(a), on a first interlayer insulating film 1 in which a lower-layer interconnect 2 is formed are sequentially formed a silicon nitride film 3 and a second interlayer insulating film 4. Then in the second interlayer insulating film 4 is formed a concave having an interconnect pattern, in a part of which is formed a connecting hole reaching the lower-layer interconnect 2.

Then, as shown in FIG. 3(b), a barrier metal film 5 is formed by sputtering. On the whole surface of the film is formed a copper film 6 by plating such that the concave is filled with the material. The thickness of the plating is larger than the sum of the depth of the trench, the depth of the connecting hole and a manufacturing dispersion in the plating step.

As shown in FIG. 3(c), the copper film 6 is polished by CMP using a polishing pad in the presence of a polishing slurry to make the substrate surface flat. Polishing is continued until the metal over the second insulating film 4 is completely removed, as shown in FIG. 3(d).

A slurry for CMP for polishing copper generally comprises an oxidizing agent and polishing grains. A basic mechanism is that the copper surface is etched by chemical action of the oxidizing agent while the oxidized surface layer is mechanically removed by polishing grains.

Primary particles of α-alumina with an average diameter of several hundred nm (30 in FIG. 1(b)) have been conventionally used as polishing grains used in a polishing slurry having a large polishing rate for a copper film, because primary particles having a desired average diameter can be easily manufactured and have a higher polishing rate.

As a semiconductor device has been more refined and more integrated, leading to a more complicated device structure, and as there has been increased the layer number of a multilayer aiming at reduction in an interconnect length for dealing with increase in an interconnect resistance associated with refinement of an interconnect or a multilayer in a logic system, a substrate surface has been more bumpy and its level difference has been larger. An upper interconnect in a multilayer interconnect is used for a source interconnect, a signal interconnect or a clock interconnect, and therefore, an interconnect trench must be deeper for improving some properties by reducing resistances in these interconnects. As a result, an interlayer insulating film formed on such a substrate surface has become thicker and thus it has been necessary to form a thick copper film by which a deep concave can be filled, for forming a damascene conductive part such as a damascene copper interconnect or via plug in a thick interlayer insulating film. For reducing a resistance of a refined interconnect or reducing a resistance of a signal or clock interconnect to improve a conduction speed, it is necessary to form an interconnect which is thick in a depth direction, so that a thick copper film is formed for providing a deep concave. When a source interconnect is formed with a damascene copper interconnect, a thick copper film is formed for reducing a resistance of the source interconnect for minimizing a potential change. While conventionally a copper film with a thickness of about several hundred nm has been adequately useful, several thousand nm may be sometimes required for a copper film.

When forming a damascene conductive part by forming such a thick copper film, the amount of copper to be removed by polishing during one CMP step increases, so that a large amount of polishing scrape such as copper or copper oxide adheres to and is accumulated on the surface of a polishing pad. As a result, a polishing rate may become too low to continue polishing or a polished surface cannot be uniform. It is now needed to make a wafer larger for improving a productivity. However, as a wafer becomes larger, an area of a copper film increases, and therefore the amount of copper to be removed by polishing has been increasing. A polishing scrapes such as copper or copper oxide generated during polishing a copper metal film is herein designated a “polishing product”.

A surface plate in a CMP apparatus cannot be so large in the light of factors such as ensuring in-plane uniformity of the surface plate, even diffusivity of a dropped polishing slurry, limitation in an area where the CMP apparatus is placed, workability in replacing a polishing pad and ensuring cleanliness in a clean room.

Increase of the amount of polished copper reduces a throughput at the same polishing rate as that for a thinner film. It is, therefore, necessary to increase a polishing rate for copper. Increase of a polishing rate for copper, however, leads to a large amount of polishing product in a short time, so that adhesion of copper to the surface of the polishing pad becomes more significant.

When a large amount of polishing product adheres to the surface of the polishing pad as described above, the polishing pad must be washed or replaced after every polishing, and furthermore, polishing must be repeated after washing or replacing the polishing pad, resulting in significant reduction in a throughput.

JP-A 10-116804 has demonstrated the problem that copper ions generated during CMP are accumulated on a polishing pad and again adhere to a wafer surface to deteriorate uniformity of the wafer surface and cause electric short-circuit, and has described that the problem can be solved by using a polishing composition comprising a re-adhesion inhibitor such as benzotriazole. The publication has mentioned the problem due to re-adhesion of copper ions on the wafer surface, but there are no descriptions for the above due to adhesion of a polishing product to a polishing pad surface. Benzotriazole used as a re-adhesion inhibitor may act as an antioxidant (J. B. Cotton, Proc. 2nd Intern. Congr. Metallic Corrosion, p.590(1963); D. Chadwick et al., Corrosion Sci., 18, p.39(1978); T. Notodani, Bousei Kanri, 26(3) p.74;(1982); H. Okabe ed., “Sekiyu Seihin Tenkazai no Kaihatsu to Saishin Gijutsu”, CMC, p.77-82(1998)), there is a limitation to the amount of the agent for reducing a polishing rate for copper. Furthermore, benzotriazole is originally added for preventing dishing (JP-As 8-83780 and 11-238709). When prevention of dishing is given priority, the amount of the agent is limited.

JP-A 10-44047 has described that polishing grains may be aggregates of a metal oxide with a diameter distribution of less than about 1.0 μm and an average aggregate diameter of less than about 0.4 μm, or separate spherical particles of a metal oxide comprising primary particles of less than 0.4 μm. Objectives of the invention described in the publication are, however, to prevent surface defects or contamination due to CMP, to form a uniform metal layer and a uniform film, and to control selectivity between a barrier film and a polishing pad surface. There are no descriptions about problems caused by adhesion of a polishing product to a polishing pad surface in the publication. In addition, the publication has listed common precipitated alumina or fumed alumina as an alumina polishing material, but has not mentioned θ-alumina at all. Furthermore, copper is listed only as a connection material and in its examples, only Al is used.

JP-A 10-163141 has described θ-alumina as polishing grains. This publication, however, has described θ-alumina as an example of an aluminum oxide together with other aluminas such as α-alumina, but has not mentioned secondary particles of θ-alumina at all. The invention described in the publication is for preventing scratches or dishing and for providing a polishing composition with a proper selectivity and exhibiting good storage stability, and there are no descriptions about preventing adhesion of a polishing product to a polishing pad surface.

JP-A 10-46140 has described a polishing composition comprising a particular carboxylic acid, an oxidizing agent and water whose pH is adjusted by an alkali to 5 to 9. Examples in the publication have disclosed a polishing composition containing citric acid as a carboxylic acid and aluminum oxide as polishing grains (Example 7). However, this publication has described only improvement in a polishing rate and prevention of occurring dishing associated with a corrosion mark as effects of addition of an organic acid such as citric acid.

JP-A 11-21546 has disclosed a slurry for chemical mechanical polishing comprising urea, a polishing material, an oxidizing agent, a film-forming agent and a complex-forming agent. Examples in this publication have described alumina as a polishing material, hydrogen peroxide as an oxidizing agent, benzotriazole as a film-forming agent and citric acid as a complex-forming agent. The publication, however, has described only that addition of the complex-forming agent is effective for disturbing a passive layer formed by a film-forming agent such as benzotriazole and for limiting a depth of an oxidizing layer.

### SUMMARY OF THE INVENTION

An objective of this invention is to provide a slurry for chemical mechanical polishing, which can prevent adhesion of a polishing product to a polishing pad and can satisfactorily polish a metal surface to a desired amount by one polishing operation without discontinuing the polishing operation, even when polishing a large amount of copper metal.

To achieve the objective, this invention provides a slurry for chemical mechanical polishing for polishing a copper-containing metal film, comprising θ-alumina mainly comprising secondary particles made of aggregated primary particles as polishing grains, an oxidizing agent and an organic acid.

The polishing slurry of this invention can be used to prevent adhesion of a polishing product to a polishing pad and to satisfactorily polish a metal surface by CMP to a desired amount in one polishing operation without discontinuing the polishing operation, even when polishing a large amount of copper due to a thick or large copper film.

### BRIEF DESCRIPTION OF THE DRAWINGS

FIG. 1 schematically illustrates the structure of alumina polishing grains.

FIG. 2 shows variation in a maximum diameter and an average diameter of θ-alumina plotted to a dispersion time.

FIG. 3 is a process cross section illustrating a process for forming a damascene copper interconnect.

### DETAILED DESCRIPTION

Preferred embodiments of this invention will be described.

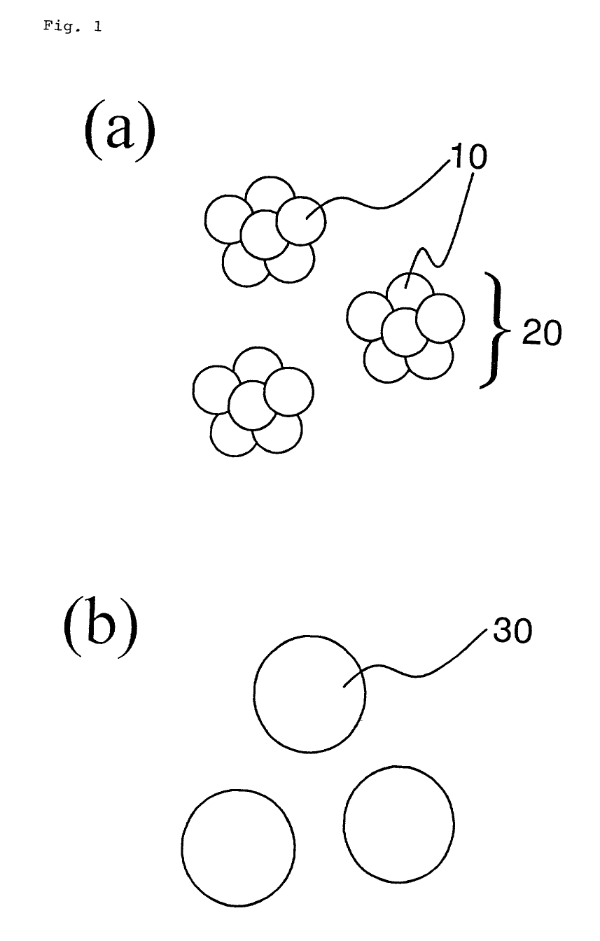

A slurry for chemical mechanical polishing (hereinafter, referred to as a “polishing slurry”) comprises, as shown in FIG. 1(a), θ-alumina mainly containing secondary particles 20 (hereinafter, referred to as “secondary-particle-containing θ-alumina”) made of aggregated primary particles 10 as polishing grains. Such a polishing slurry allows us to prevent adhesion of a polishing product to a polishing pad and to continue satisfactory polishing without discontinuing polishing operation, even when polishing a thick or large copper metal film, i.e., when polishing a large amount of copper metal during one polishing operation. As used herein, the term “a copper metal” or “a copper-containing metal” means copper or an alloy mainly containing copper.

The content of secondary particles in the secondary-particle-containing θ-alumina is preferably at least 60 wt %, more preferably at least 65 wt %, further preferably at least 70 wt % to the total amount of the secondary-particle-containing θ-alumina for more completely preventing adhesion of a polishing product to a polishing pad.

The average diameter of the secondary particles is preferably at least 0.05 μm, more preferably at least 0.07 μm. further preferably at least 0.08 μm; and preferably 0.5 μm or less, more preferably 0.4 μm or less, further preferably 0.3 μm or less.

The proportion of secondary particles having a diameter of 0.05 μm to 0.5 μm both inclusive in the total amount of secondary-particle θ-alumina is preferably at least 50 wt %, more preferably at least 55 wt %, further preferably at least 60 wt %.

In addition, it is desirable that secondary-particle-containing θ-alumina substantially contains neither primary nor secondary particle having a diameter of more than 2 μm, more preferably more than 1.5 μm, further preferably more than 1 μm.

The average diameter of primary particles constituting secondary-particle θ-alumina described above is preferably at least 0.005 μm, more preferably at least 0.007 μm, further preferably at least 0.008 μm; and preferably 0.1 μm or less, more preferably 0.09 μm or less, further preferably 0.08 μm or less.

The average diameter of primary particles constituting secondary-particle-containing θ-alumina in this invention is considerably smaller than that of primary particles of α-alumina commonly used as a conventional polishing grains. The average diameter of secondary particles consisting of such primary particles may be, therefore, adjusted to about that of primary particles of the conventional α-alumina. When conducting CMP using a polishing slurry comprising such θ-alumina mainly containing the secondary particles (secondary-particle-containing θ-alumina) as a main component in polishing grains, a polishing product generated after mechanical removal is small because a contact area is small between a polished surface of copper and a primary particle constituting a secondary particle. Furthermore, a polishing product is further pulverized to provide a finer polishing product by spaces between primary particles constituting secondary particles or an irregular surface.

Secondary-particle-containing θ-alumina has a larger surface area than a primary particle of a conventional α-alumina. It, therefore, exhibits good dispersibility, which may prevent forming a giant particle due to association of secondary particles. Thus, it may prevent generation of a large size polishing product from a polished surface due to scratching by a giant particle.

As described above, in CMP using a polishing slurry of this invention, a polishing product generated is so small that clogging with the polishing product can be minimized in the polishing pad surface while a fine polishing product can be readily washed out by the polishing slurry which is continuously fed. Thus, polishing pad contamination can be prevented even when a large amount of copper is removed by polishing.

In CMP using the polishing slurry of this invention, scratches in a polished surface may be also prevented in addition to effect of inhibiting polishing pad contamination. Since secondary-particle-containing θ-alumina can be deformed by a polishing load (a contact pressure of the polishing pad) from a polishing pad, stress concentration can be avoided in a contact area between the polished surface and a primary particle constituting a secondary particle. Consequently, the polished surface may not be significantly removed and thus may prevent scratches.

θ-alumina has a Mohs' hardness of 7 while α-alumina has 9. In other words, θ-alumina has a lower hardness than α-alumina, and has a proper hardness for polishing a soft metal such as copper, leading to prevention of scratches.

Furthermore, a secondary particle in secondary-particle-containing θ-alumina has a large surface area and thus exhibits good dispersibility, and a primary particle is extremely small. The polishing slurry of this invention, therefore, has a property of good long term stability.

An average diameter of polishing grains, a proportion of grains having a particular range of diameter and a maximum diameter may be estimated by determining a diameter distribution of polishing grains by a light scattering method and statistically processing the diameter distribution obtained. Furthermore, a diameter distribution of polishing grains may be determined by measuring a diameter for an adequately large number of polishing grains using an electron microscope.

θ-alumina may be prepared by removing crystal water from a colloid made of an Al-containing salt hydrate or hydroxide by heating under controlling a programming rate. A secondary particle is an aggregate formed by fusion of contact parts in primary particles during heating. Since it is possible to prepare fine colloid particles whose diameter is controlled in preparation of θ-alumina, fine primary particles having an average diameter and a diameter distribution suitable to this invention may be prepared. It may, therefore, allow us to form secondary particles of θ-alumina having a similar diameter to primary particles of conventional α-alumina. Furthermore, since a binding strength of fusion between primary particles formed during heating is within a proper range, dispersion under appropriate conditions may break a bond between several primary particles to form secondary particles with a diameter suitable to this invention.

Secondary-particle-containing θ-alumina contained in a polishing slurry of this invention may be prepared by dispersing 0-alumina prepared as described above into a dispersive medium under appropriate conditions. θ-alumina prepared by heating a colloid consists of giant aggregates with an average diameter of about 10 μm, consisting of a number of fused primary particles. It is added to an aqueous medium within a range of 10 wt % to 70 wt % both inclusive. A dispersing agent may be, if necessary, added within a range of 0.01 wt % to 10 wt %. The amounts of θ-alumina and the dispersing agent affect a diameter of secondary particles obtained.

Dispersion may be conducted using, for example, an ultrasonic disperser, a bead mill disperser, a ball mill disperser or a kneader disperser. Among these, a bead mill or ball mill disperser may be preferably used because it may stably form secondary particles with a desirable diameter. Furthermore, a filter mechanism may be provided to the disperser for removing particles with a diameter of 2 μm or more.

A dispersion time, which affects a diameter distribution, is preferably at least 140 min, more preferably at least 150 min, further preferably at least 180 min for providing secondary particles with a highly monodisperse diameter distribution. In the light of preventing contamination with foreign matters, dispersion time is preferably 400 min or less, more preferably 350 min or less, further preferably 300 min or less.

A dispersing agent may consist of at least one of surfactant and aqueous polymer types of dispersing agents.

Examples of surfactant dispersing agents include anionic, cationic, ampholytic and nonionic surfactants. Anionic surfactants which may be used include soluble salts of sulfonic acids, sulfates, carboxylic acids, phosphates and phosphonates; for example, sodium alkylbenzenesulfonate (ABS), sodium dodecylsulfate (SDS), sodium stearate and sodium hexamethaphosphate. Cationic surfactants include amine salts containing a salt-forming primary, secondary or tertiary amine and their modified salts; onium compounds such as quaternary ammonium, phosphonium and sulfonium salts; circular nitrogen-containing compounds such as pyridinium, quinolium and imidazolinium salts; and heterocyclic compounds; for example, cetyl-trimethyl-ammonium chloride (CTAC), cetyl-trimethyl-ammonium bromide (CTAB), cetylpyridinium chloride, dodecylpyridinium chloride, alkyl-dimethylchlorobenzyl-ammonium chloride and alkyl-naphthalene-pyridinium chloride.

Nonionic surfactants include products of addition polymerization of a fatty acid with ethylene oxide such as polyethyleneglycol fatty acid esters, polyoxyethylene alkyl ethers, polyoxyethylene alkylphenyl ethers; ether types of nonionic surfactants; and polyethyleneglycol condensation types of surfactants; for example, POE (10) monolaurate, POE (10) monostearate, POE (25) monostearate, POE (40) monostearate, POE (45) monostearate, POE (55) monostearate, POE(21) lauryl ether, POE(25) lauryl ether, POE(15) cetyl ether, POE(20) cetyl ether, POE(23) cetyl ether, POE(25) cetyl ether, POE(30) cetyl ether, POE(40) cetyl ether, POE(20) stearyl ether, POE(2) nonyl phenyl ether, POE(3) nonyl phenyl ether, POE(5) nonyl phenyl ether, POE(7) nonyl phenyl ether, POE(10) nonyl phenyl ether, POE(15) nonyl phenyl ether, POE(18) nonyl phenyl ether, POE(20) nonyl phenyl ether, POE(10) octyl phenyl ether, POE(30) octyl phenyl ether, POE(6) sorbitan monooleate, POE(20) sorbitan monooleate, POE(6) sorbitan monolaurate, POE(20) sorbitan monolaurate, POE(20) sorbitan monopalmitate, POE(6) sorbitan monostearate, POE(20) sorbitan monostearate, POE(20) sorbitan tristearate, POE(20) sorbitan trioleate, POE(6) sorbitan tmonooleate and POE(20) sorbitan tmonooleate, wherein POE represents polyoxyethylene and a number in parentheses is the number of the repeating unit —CH₂CH₂O—.

Amphoteric surfactants include which may be used include compounds intramolecularly having at least one anion-forming atomic group selected from —COOH, —SO₃H, —OSO₃H and —OPO₃H₂ groups and cation-forming atomic group selected from primary, secondary and tertiary amine groups and quaternary ammonium groups; for example, betaines, sulfobetaines and sulfatebetaines; more specifically, lauryl dimethylaminoacetate betaine and sodium N-palm oil fatty acid-N-carboxymethyl-N-hydroxyethylenediamine.

Aqueous polymer dispersing agents include ionic and nonionic polymers. Ionic polymers include alginic acid and its salts, polyacrylic acid and its salts, a polycarboxylic acid and its salts, cellulose, carboxymethylcellulose and hydroxylethylcellulose. Nonionic polymers include polyvinyl alcohol, polyvinylpyrrolidone, polyethylene glycol and polyacrylamide.

A weight-average molecular weight of an aqueous polymer dispersing agent is preferably at least 100, more preferably at least 500, further preferably at least 1000; and preferably 100000 or less, more preferably 80000 or less, further preferably 50000 or less. A weight-average molecular weight within the range may inhibit increase in a viscosity of a slurry obtained to provide secondary-particles with a good diameter distribution.

As long as it does not adversely affect the effects of secondary-particle-containing θ-alumina, additional polishing grains may be used, which includes aluminas such as α-alumina and δ-alumina other than θ-alumina; silicas such as fumed silica and colloidal silica; titania; zirconia; germania; ceria; and a mixture of two or more selected from these metal oxide polishing grains.

The content of secondary-particle-containing θ-alumina is preferably at least 1 wt %, more preferably at least 3 wt %; and preferably 30 wt % or less, more preferably 10 wt % or less to the total amount of the chemical mechanical polishing slurry. When the polishing slurry contains two or more types of polishing grains, the sum of the contents of individual polishing grains is preferably at least 1 wt %, more preferably at least 3 wt %; and preferably 30 wt % or less, more preferably 10 wt % or less.

The oxidizing agent contained in a polishing slurry of this invention may be selected from known water-soluble oxidizing agents in the light of polishing accuracy and a polishing efficiency. For example, those which may not cause heavy-metal ion contamination include peroxides such as H₂O₂, Na₂O₂, Ba₂O₂ and (C₆H₅C)₂O₂; hypochlorous acid (HClO); perchloric acid; nitric acid; ozone water; and organic acid peroxides such as peracetic acid and nitrobenzene. Among these, hydrogen peroxide (H₂O₂) is preferable because it does not contain a metal component and does not generate a harmful byproduct. The content of the oxidizing agent in the polishing slurry of this invention is preferably at least 0.01 wt %, more preferably at least 0.05 wt %, further preferably at least 0.1 wt % to the total amount of the slurry, for achieving adequate effects of its addition; and preferably 15 wt % or less, more preferably 10 wt % or less, for preventing dishing and adjusting a polishing rate to a proper value. When using an oxidizing agent which is relatively susceptible to deterioration with age such as hydrogen peroxide, it may be possible to separately prepare a solution containing an oxidizing agent at a given concentration and a composition which provides a given polishing slurry after addition of the solution containing an oxidizing agent, which are then combined just before use.

As an organic acid, a carboxylic acid or amino acid may be added as a proton donor for enhancing oxidization by the oxidizing agent and achieving stable polishing.

Carboxylic acids include oxalic acid, malonic acid, tartaric acid, malic acid, glutaric acid, citric acid, maleic acid, formic acid, acetic acid, propionic acid, butyric acid, valeric acid, acrylic acid, lactic acid, succinic acid, nicotinic acid and their salts.

In particular, citric acid is preferable because it may easily form a complex with a copper ion to prevent contamination of a polishing pad. A synergetic effect of complex-forming action of citric acid and action of secondary-particle-containing θ-alumina may further prevent contamination of the polishing pad.

An amino acid may be added as its free form, as a salt or as a hydrate. Examples of those which may be added include arginine, arginine hydrochloride, arginine picrate, arginine flavianate, lysine, lysine hydrochloride, lysine dihydrochloride, lysine picrate, histidine, histidine hydrochloride, histidine dihydrochloride, glutamic acid, glutamic acid hydrochloride, sodium glutaminate monohydrate, glutamine, glutathione, glycylglycine, alanine, β-alanine, γ-aminobutyric acid, ε-aminocarproic acid, aspartic acid, aspartic acid monohydrate, potassium aspartate, potassium aspartate trihydrate, tryptophan, threonine, glycine, cystine, cysteine, cysteine hydrochloride monohydrate, oxyproline, isoleucine, leucine, methionine, ornithine hydrochloride, phenylalanine, phenylglycine, proline, serine, tyrosine, valine, and a mixture of these amino acids.

The content of the organic acid is preferably at least 0.01 wt %, more preferably at least 0.05 wt % to the total amount of the polishing slurry, for achieving adequate effects of its addition; and preferably 5 wt % or less, more preferably 3 wt % or less, for preventing dishing and adjusting a polishing rate to a proper value. When the polishing slurry comprises a plurality of organic acids, the above content means the total of the contents of these individual organic acids.

An antioxidant may be further added to a polishing slurry in this invention. Addition of an antioxidant may allow a polishing rate for a copper metal film to be easily adjusted and may result in forming a coating film over the surface of the copper metal film to prevent dishing.

Examples of an antioxidant include benzotriazole, 1,2,4-triazole, benzofuroxan, 2,1,3-benzothiazole, o-phenylenediamine, m-phenylenediamine, cathechol, o-aminophenol, 2-mercaptobenzimidazole, 2-mercaptobenzoxazole, melamine, and their derivatives. Among these, benzotriazole and its derivatives are preferable. Examples of a benzotriazole derivative include substituted benzotriazoles having a benzene ring substituted with hydroxy; alkoxy such as methoxy and ethoxy; amino; nitro; alkyl such as methyl, ethyl and butyl; halogen such as fluorine, chlorine, bromine and iodine. Furthermore, naphthalenetriazole and naphthalenebistriazole as well as substituted naphthalenetriazoles and substituted naphthalenebistriazoles substituted as described above may be used.

The content of the antioxidant is preferably at least 0.0001 wt %, more preferably at least 0.001 wt % to the total amount of the polishing slurry, for achieving adequate effects of its addition; and preferably 5.0 wt % or less, more preferably 2.5 wt % or less, for adjusting a polishing rate to a proper value.

In the light of a polishing rate and corrosion, a slurry viscosity and dispersion stability of a polishing material, pH for a polishing slurry is preferably at least 3, more preferably at least 4; and preferably 9 or less, more preferably 8 or less.

For the polishing slurry, pH may be adjusted by a known technique. For example, an alkali may be directly added to a slurry in which polishing grains are dispersed and a carboxylic acid is dissolved. Alternatively, a part or all of an alkali to be added may be added as a carboxylic acid alkali salt. Examples of an alkali which may be used include alkali metal hydroxides such as sodium hydroxide and potassium hydroxide; alkali metal carbonates such as sodium carbonate and potassium carbonate; ammonia; and amines.

A polishing slurry of this invention may contain a variety of additives such as buffers and viscosity modifiers commonly added to a polishing slurry as long as it does not deteriorate the properties of the slurry.

A polishing slurry of this invention may be suitably used for polishing a substrate comprising a copper metal on its surface, even when polishing the copper metal with a polishing amount of at least 2×10⁻⁴ g/cm², further at least 1×10⁻³ g/cm², more further at least 1×10⁻² g/cm² per 1 cm² of the polishing pad in one polishing operation, without contamination of the polishing pad.

A composition of the polishing slurry of this invention is preferably adjusted such that a polishing rate for a copper metal film becomes preferably at least 300 nm/min, more preferably at least 400 nm/min. Furthermore, a composition of the polishing slurry of this invention is preferably adjusted such that a polishing rate for a copper metal film becomes preferably 1500 nm/min or less, more preferably 1000 nm/min or less.

In an apparatus for CMP, a wafer on which a copper metal film is deposited is placed on a spindle wafer carrier. The surface of the wafer is contacted with a polishing pad made of, e.g., porous urethane adhered on a rotary plate (surface plate). While supplying a polishing slurry to the surface of the polishing pad from a polishing slurry inlet, both the wafer and the polishing pad are rotated to polish the wafer. If necessary, a pad conditioner is contacted with the surface of the polishing pad to condition the surface of the polishing pad.

At the end of CMP, the polishing slurry inlet is closed to stop feeding of the polishing slurry, and then a washing is fed from another inlet for rinsing for 15 to 30 sec. Subsequently, megasonic washing is conducted while keeping the wafer wet, to remove the polishing slurry and then the wafer is dried.

A polishing slurry of this invention described above may be most effectively applied to a process for forming an electric connection part such as a damascene interconnect, a via plug and a contact plug by CMP of a substrate where a barrier metal film is formed on an insulating film having a concave such as a trench and an opening and a copper metal film is formed over the whole surface of the insulating film such that the concave is filled with the metal. Examples of a barrier metal include Ta, TaN, Ti and TiN. Examples of an insulating film include a silicon oxide film, a BPSG film and an SOG film. Examples of a copper metal film include a copper film as well as a copper alloy film comprising a metal selected from a variety of conductive metals such as silver, gold, platinum, titanium, tungsten, aluminum.

The polishing slurry of this invention can be used to prevent adhesion of a polishing product to a polishing pad and to satisfactorily remove a large amount of copper metal by CMP in one polishing operation without discontinuing the polishing operation, even when polishing a large amount of copper due to a thick or large copper film.

Since a polishing slurry of this invention may be used to prevent adhesion of a polishing product not only on a polishing pad surface but also on a polished surface during polishing, an excellent polished surface having good flatness may be formed without problems of device properties such as electric short-circuit between interconnects.

This invention will be more specifically described with reference to Examples.

Preparation of a secondary-particle-containing θ-alumina dispersion

Secondary-particle-containing θ-alumina was prepared using θ-alumina (Sumitomo Chemical Co., Ltd.; AKP-G008). Observation of the θ-alumina before preparation by SEM indicated that it consisted of aggregates made of a number of fused primary particles with the minimum and the maximum diameters of 0.03 μm and 0.08 μm (the average diameter: 0.05 μm), respectively. The average diameter of the aggregates were 10 μm. Although there were sometimes observed primary particles with a diameter considerably smaller or larger in relation to the minimum or the maximum diameters, respectively, they did not affect properties of a polishing slurry finally obtained or contribute an average diameter at all.

Then, Aqualic HL415, a dispersing agent from Nippon Shokubai Co., Ltd., was added to ion-exchanged water to 4 wt %, and then θ-alumina before preparation was added to 40 wt %. The resultant mixture was subject to dispersion at a rotating speed of 1000 rpm using a bead mill (Inoue Seisakusho; Super mill). A plurality of dispersions were prepared, varying a dispersion time from 20 to 400 min.

A diameter distribution for the overall particles was determined for the θ-alumina contained in each dispersion using a diameter analyzer (Beckmann-Kolter; LS-230). The maximum diameter was determined from the diameter distribution for the overall particles. A diameter distribution for secondary particles was calculated by subtracting the diameter distribution for primary particles from that for the overall particles. An average diameter of secondary particles was determined by statistically processing the particle distribution of secondary particles. Furthermore, for a dispersion in which a dispersion time was 200 min, were determined the content of secondary particles to the overall secondary-particle-containing θ-alumina and the proportion of secondary particles with a diameter of 0.05 μm to 0.5 μm both inclusive to the overall secondary particles.

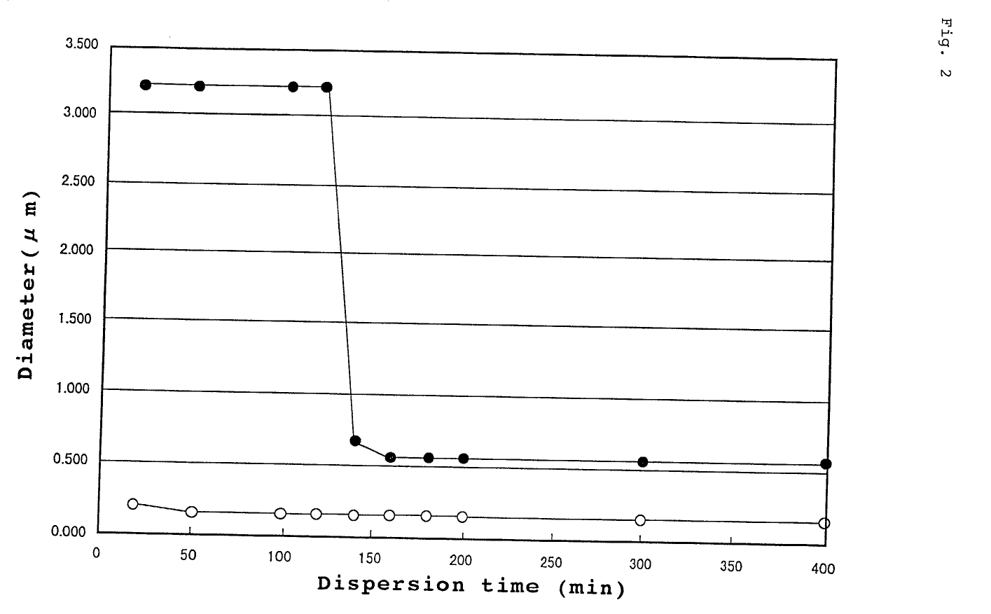

FIG. 2 shows the maximum diameter (●) and an average diameter (∘) of secondary particles for θ-alumina in a dispersion at several dispersion times. Large secondary particles with a diameter of more than 3 μm were present for a dispersion time of 120 min or shorter, while the maximum diameter was less than 1 μm for a dispersion time of 140 min or longer.

When a dispersion time was 200 min, the average diameter of secondary particles was 0.15 μm, the maximum diameter was 0.6 μm, the content of secondary particles to the overall secondary-particle-containing θ-alumina was 74 wt %, and the proportion of secondary particles having a diameter of 0.05 μm to 0.5 μm both inclusive to the overall secondary particles was 62 wt %. In addition, there were observed no significant foreign matters.

### Example 1

Among the dispersions prepared as described above, the dispersion in which a dispersion time was 200 min was used to prepare polishing slurry 1 with pH 7 comprising 5.03 wt % of secondary-particle-containing θ-alumina, 0.47 wt % of citric acid and 1.9 wt % of H₂O₂, in which pH was adjusted with ammonia, and H₂O₂ was added just before CMP.

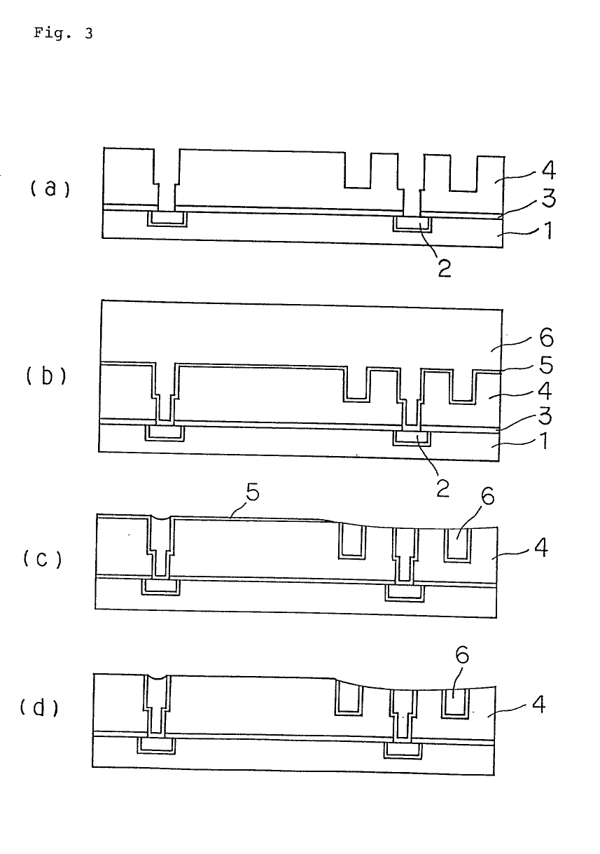

As shown in FIG. 3(a), on a 6 inch wafer (silicon substrate, not shown) in which a semiconductor device such as a transistor was formed was deposited a first silicon oxide film 1 comprising a lower interconnect 2 (not shown). On the film 1 were formed a silicon nitride film 3 and a second silicon oxide film 4 with a thickness of about 1.5 μm. The second silicon oxide film 4 was then patterned as usual by, for example, lithography and reactive ion etching to form a trench for interconnection and in a given area of the trench a connection hole reaching the lower interconnect 2. Then, Ta film with a thickness of 50 nm was formed by sputtering, a copper film with a thickness of about 50 nm was formed by sputtering, and then a copper film 6 with a thickness of about 2 μm was formed by plating.

The copper film was subject to CMP using polishing slurry 1. CMP was conducted using a Speedfam-Ipec Type SH-24 apparatus. The polisher was used, on whose surface plate a polishing pad (Rodel-Nitta IC 1400) with a diameter of 61 cm (24 inch) was attached. Polishing conditions were as follows: a contact pressure (polishing pressure) of the polishing pad: 27.6 kPa; a polishing area of the polishing pad: 1820 cm²; a rotating speed of the surface plate: 55 rpm; a carrier rotating speed: 55 rpm; and a polishing slurry feeding rate: 100 mL/min. After polishing the copper film by about 2 μm, contamination of the polishing pad was evaluated visually or on the basis of a polishing rate.

The above copper film was polished by about 2 μm. A polishing rate was constant and polishing was stable until termination of polishing. Then, contamination of the polishing pad was visually evaluated, and it was found that there was little adhesion of a polishing product to the polishing pad. SEM observation of the polished surface indicated that scratches were prevented.

### Example 2

Polishing slurry 2 was prepared as described for polishing slurry 1, replacing citric acid with malic acid. Using polishing slurry 2, CMP was conducted as described above. A polishing rate was constant and polishing was stable until termination of polishing. Then, contamination of the polishing pad was evaluated as described above, and it was found that there was little adhesion of a polishing product to the polishing pad. SEM observation of the polished surface indicated that scratches were prevented.

### Comparative Example 1

Polishing slurry 3 was prepared as described for polishing slurry 2, replacing θ-alumina with commercially available α-alumina. Using polishing slurry 3, CMP and evaluation of the polishing pad were conducted as described above, and it was found that a large amount of a polishing product adhered to the polishing pad.

What is claimed is:

1. A slurry for chemical mechanical polishing for polishing a copper-containing metal film, comprising θ-alumina mainly comprising secondary particles made of aggregated primary particles as polishing grains, an oxidizing agent and an organic acid.

2. A slurry for chemical mechanical polishing as claimed in claim 1, wherein a content of the θ-alumina is 1 wt % to 30 wt % both inclusive to a total amount of the slurry for chemical mechanical polishing.

3. A slurry for chemical mechanical polishing as claimed in claim 1, wherein a content of the secondary particles of the θ-alumina is 60 wt % or more to a total amount of the θ-alumina.

4. A slurry for chemical mechanical polishing as claimed in claim 1, wherein an average diameter of the secondary particles of the θ-alumina is 0.05 μm to 0.5 μm both inclusive.

5. A slurry for chemical mechanical polishing as claimed in claim 1, wherein the θ-alumina comprises 50 wt % or more of the secondary particles having a diameter of 0.05 μm to 0.5 μm both inclusive to a total amount of the secondary particles.

6. A slurry for chemical mechanical polishing as claimed in claim 1, wherein primary and secondary particles having a diameter of more than 2 μm are substantially absent in the θ-alumina.

7. A slurry for chemical mechanical polishing as claimed in claim 1, wherein an average diameter of the primary particles of the θ-alumina is 0.005 μm to 0.1 μm both inclusive.

8. A slurry for chemical mechanical polishing as claimed in claim 1, wherein a content of the organic acid is 0.01 wt % to 5 wt % both inclusive to a total amount of the slurry for chemical mechanical polishing.

9. A slurry for chemical mechanical polishing as claimed in claim 1, comprising citric acid in a range of 0.01 wt % to 5 wt % both inclusive to a total amount of the slurry for chemical mechanical polishing.

10. A slurry for chemical mechanical polishing as claimed in claim 1, wherein pH is 4 to 8 both inclusive.

11. A slurry for chemical mechanical polishing as claimed in claim 1, wherein a content of the oxidizing agent is 0.01 wt % to 15 wt % both inclusive to a total amount of the slurry for chemical mechanical polishing.

12. A slurry for chemical mechanical polishing as claimed in claim 1, comprising an antioxidant in a range of 0.0001 wt % to 5 wt % both inclusive to a total amount of the slurry for chemical mechanical polishing.
